(19) United States
(12) Patent Application Publication
(10) Pub. No.: US 2006/0053278 A1
(43) Pub. Date: Mar. 9, 2006

(54) Encryption device

(75) Inventors: Yoshifumi Tanimoto, Osaka (JP); Kazuo Soumiya, Kyoto-shi (JP); Shigeki Takeuchi, Otsu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 11/220,629

(22) Filed: Sep. 8, 2005

(30) Foreign Application Priority Data
Sep. 9, 2004 (JP) 2004-261760

(51) Int. Cl. H04L 9/00

(52) U.S. Cl. 713/150

(57) ABSTRACT

An encryption device which enables a client not having an encryption function to easily use a function of encrypted mail without carrying out a management of certification and a key and an encryption and a decryption. When an Internet facsimile machine transmits electronic mail to an encryption device, the encryption device converts the received electronic mail into encrypted mail and transmits to a mail server. When another Internet facsimile machine transmits data including a part to be encrypted and transmission destination information as a main body of mail to an encryption and decryption I/F of the encryption device, the encryption device encrypts the main body of the received mail under a prescribed encryption method and sends back to the other Internet facsimile machine. Accordingly, the other Internet facsimile machine can format encrypted data into encrypted mail and transmit to a remote Internet facsimile machine.

### BACKGROUND OF THE INVENTION

1. Field of the Invention

The present invention relates to an encryption device, and in particular, relates to an encryption device which encrypts electronic mail or data by using a public key encryption method and signs an electronic signature.

2. Description of Related Art

Recently, a computer communication network such as the Internet, which distributes electronic mail, is becoming widespread. A facsimile protocol using a conventional public network differs from a communication protocol of computer communication using the abovementioned computer communication network. Therefore, communication cannot be carried out directly from a facsimile machine to the computer communication network.

However, even in case of image data of an original document or the like that is generally transmitted and received by facsimile communication, by converting the image data into an electronic mail format, the image data can be transmitted and received via the computer communication network. A development is made on the Internet facsimile machine with an electronic mail function, which can transmit and receive an original document as electronic mail by Internet communication.

In such an Internet facsimile machine, when transmitting or receiving the image data via the Internet by using electronic mail, electronic mail including the image data is transmitted via a mail server device of a transmitting end and the Internet to a mail server device of a receiving end under the Simple Mail Transfer Protocol (SMTP) method. An Internet facsimile machine of the receiving end accesses the mail server device of the receiving end and receives the electronic mail including the image data under the Post Office Protocol version 3 (POP3) method. The Internet facsimile machine of the receiving end prints out the received image data by using an image printing unit.

Meanwhile, in a site of business or the like, electronic mail has become an indispensable tool for business communication due to its convenience and promptness. However, since the electronic mail is distributed to a destination mail address via a plurality of computers (mail servers), there exists a risk of falsification. For example, during the distribution, the contents of the electronic mail may be intercepted, or the contents may be rewritten or switched with totally different contents. In addition, there also exists a risk in which a spoofer transmits the electronic mail by changing a transmitter mail address.

To avoid such risks, electronic mail is transmitted and received by using a public key encryption method.

A public key is a key publicized to a general public whom relationship with a user, who is a holder of the public key, is authenticated formally by a Certificate Authority (CA) or the like. A secret key is a counterpart of the public key. Data encrypted by the public key can only be decrypted by the secret key. Data encrypted by the secret key can only be decrypted by the public key. Therefore, electronic mail can be signed by using the secret key, and a signature of the electronic mail can be verified by using the public key. By using the public key authenticated by the CA, a detection can be carried out reliably as to whether or not data is falsified.

A process necessary for using such a public key encryption method is realized by using electronic mail software having an encryption function and previously setting own secret key and digital certification of a communication destination or the like in a terminal to be used.

As described above, conventionally, for an encryption of electronic mail, electronic mail software having an encryption function is installed. To create encrypted mail by the above-described Internet facsimile machine, electronic mail software having an encryption function is required to be installed in the Internet facsimile machine. Moreover, the Internet facsimile machine is required to be provided with a function for managing an encryption key necessary for the encryption. In addition, a public key of a destination, which becomes necessary when encrypting the electronic mail, and a public key of a transmitter, which becomes necessary for verification of a signature of the electronic mail, are required to be registered in the Internet facsimile machine. When exchanging encrypted electronic mail with a plurality of destinations, there exists a drawback that a large memory capacity is required for registering public keys.

Even in the case where facsimile machines are connected directly with one another and communication is carried out by the SMTP, there exists an urgent demand for an exchange of encrypted mails. However, there exists a drawback that a load of an encryption processing is great in built-in devices.

### SUMMARY OF THE INVENTION

The present invention has been made in consideration of the above-described circumstances. An advantage of the present invention is to provide an encryption device which enables a mail client, which carries out a transmission and a reception of electronic mail via a general mail server, and Internet facsimile machines, which transmit and receive electronic mail directly with one another without carrying out communication via the mail server, to easily use a function of encryption and a function of an electronic signature without carrying out a management of certification and a key and without carrying out an encryption and a decryption.

### BRIEF DESCRIPTION OF THE SEVERAL VIEWS OF THE DRAWINGS

FIG. 1 shows an example of a network configuration to which an encryption device is connected according to an embodiment of the present invention.

FIG. 2 is a block diagram showing a hardware configuration of the encryption device according to an embodiment of the present invention.

FIG. 3 is a functional block diagram showing a configuration of the encryption device according to an embodiment of the present invention.

FIG. 4 shows an example of certificate information registered in a certification information management unit.

FIG. 5 shows an example of information registered in a destination information management unit.

FIG. 6 shows an example of an encryption mail address and a decryption mail address assigned to the encryption device.

FIG. 7 shows an example of an encryption Uniform Resource Locator (URL) and a decryption URL assigned to the encryption device.

FIG. 8 is a flowchart showing an operation of the encryption device when encrypting electronic mail or a main body of the electronic mail.

FIG. 9 is a flowchart showing an operation of the encryption device when generating an electronic signature by using certification information unique to a client.

FIG. 10 is a flowchart showing an operation of the encryption device when decrypting encrypted mail or an encrypted data part extracted from the mail.

### DETAILED DESCRIPTION OF THE INVENTION

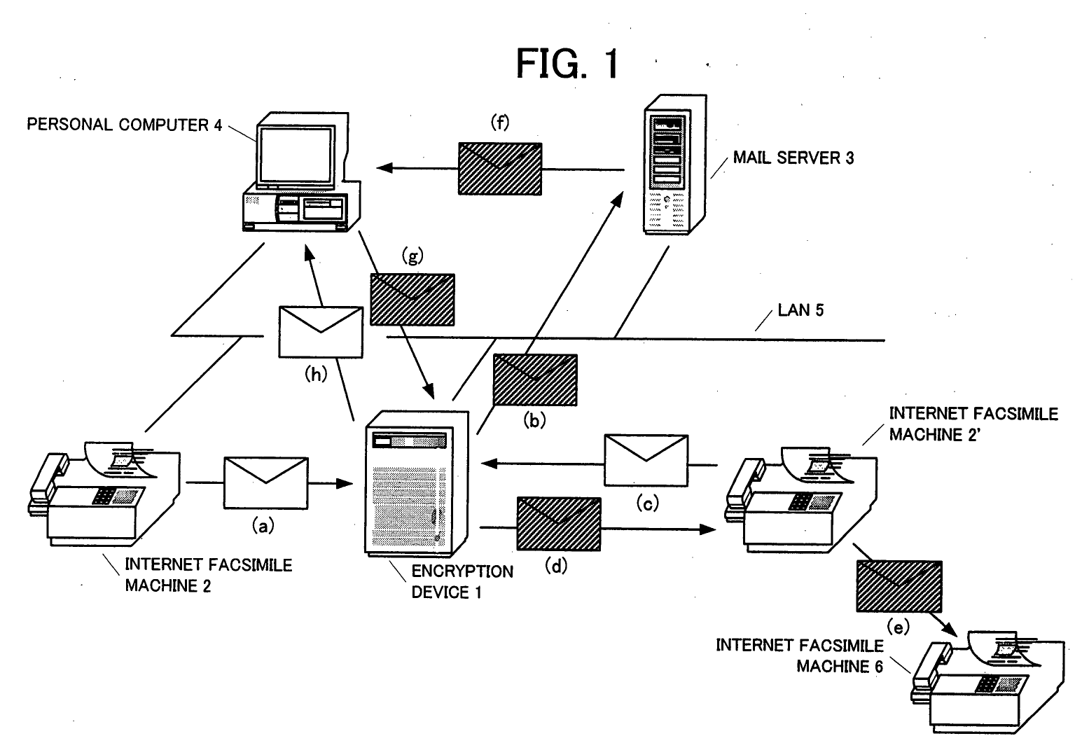

With reference to the drawings, a description will be made of an encryption device according to an embodiment of the present invention. FIG. 1 shows an example of a network configuration where an encryption device 1 according to an embodiment of the present invention is connected to a Local Area Network (LAN) 5. As shown in FIG. 1, the encryption device 1, Internet facsimile machines 2 and 2′, a mail server 3 and a personal computer 4 or the like are connected to the LAN 5.

When the Internet facsimile machine 2 transmits electronic mail (a) addressed to a destination (not shown) to the encryption device 1, the encryption device 1 extracts destination information of a transmission destination of the received electronic mail. Then, the encryption device 1 searches whether or not a destination address supports encryption in accordance with a telephone directory database. When the destination address supports the encryption, the encryption device 1 converts the electronic mail into encrypted electronic mail (b) (mail of the Secure/Multipurpose Internet Mail Extension (S/MIME) format) by using registered public key information. Then, the encryption device 1 transfers the encrypted electronic mail (b) to the mail server 3. In this case, the encryption device 1 can also assign an electronic signature in accordance with registered certification information.

When the Internet facsimile machine 2′ transmits data (c), which includes a part to be encrypted and transmission destination information, as a main body of electronic mail to an encryption and decryption interface (I/F) of the encryption device 1, the encryption device 1 extracts the transmission destination information from the received data. The encryption device 1 searches whether or not a destination address supports the encryption in accordance with the telephone directory database. When the destination address supports the encryption, the encryption device 1 encrypts the main body of the received electronic mail under a prescribed encryption method by using the registered public key information, and generates encrypted data (for example, Public Key Cryptographic Standards (PKCS) #7). In this case, in the same manner as described above, the encryption device 1 can assign an electronic signature in accordance with the registered certification information. Then, the encryption device 1 sends back encrypted data (d) to the Internet facsimile machine 2′. The Internet facsimile machine 2′ can format the encrypted data (d) into a form of encrypted electronic mail (e). Then, the Internet facsimile machine 2′ can transmit the encrypted electronic mail (e) to an actual transmission destination (for example, a remote Internet facsimile machine 6).

Meanwhile, when the personal computer 4 receives electronic mail, the personal computer 4 periodically receives the electronic mail from the mail server 3 by using account information of the personal computer 4 itself. The personal computer 4 determines whether or not the received electronic mail is encrypted. When electronic mail (f) is encrypted, the personal computer 4 transmits the received mail (mail of the S/MIME format) or encrypted data part (PKCS#7) (g) extracted from the electronic mail to the encryption and decryption I/F of the encryption device 1. The encryption device 1 decrypts the received data by using key information registered in the encryption device 1. The encryption device 1 sends back decrypted data (h) to the personal computer 4. In this case, when an electronic signature or the like is assigned, the encryption device 1 can carry out verification and add a verification result or a content of the signature or the like as a comment to the data to be sent back.

As the encryption and decryption I/F, an encryption mail address and a decryption mail address can be provided to the encryption device 1, respectively. Accordingly, an encryption and a decryption can be carried out by electronic mail between the encryption device 1 and a client such as the Internet facsimile machine 2 and the personal computer 4 (hereinafter, the Internet facsimile machine 2 and the personal computer 4 will be collectively referred to as “client”). As another example of the encryption and decryption I/F, an encryption URL (Common Gateway Interface (CGI)) and a decryption URL (CGI) can be provided to the encryption device 1, respectively. Accordingly, the encryption and the decryption can be carried out by the Hyper Text Transfer Protocol (HTTP) protocol between the encryption device 1 and the client. The present invention is not limited to these examples. For example, another communication protocol such as the File Transfer Protocol (FTP) can be adopted.

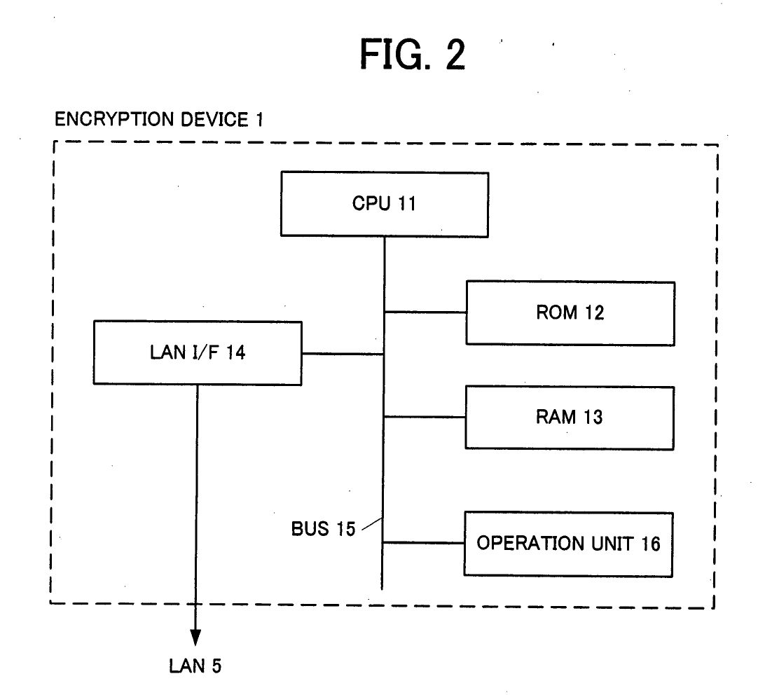

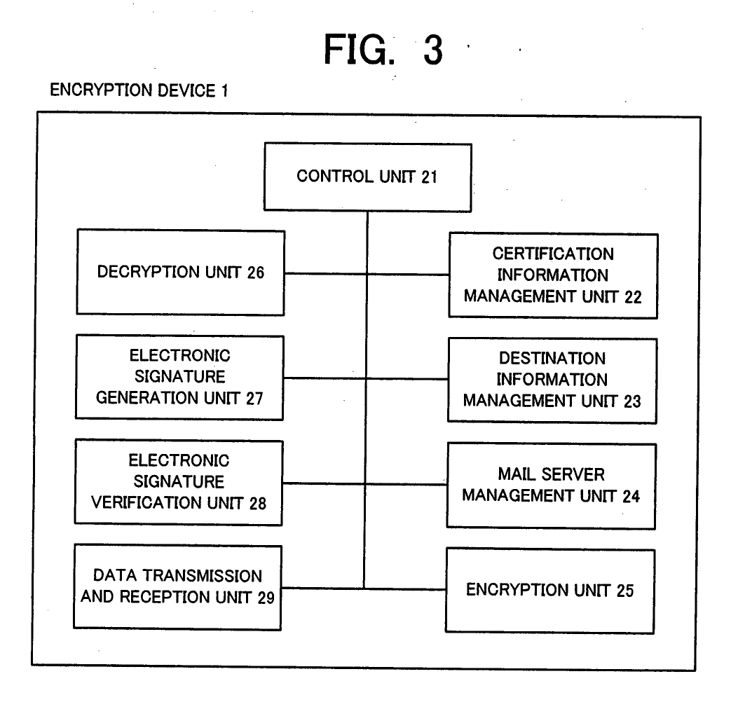

Next, referring to the block diagram of FIG. 2 and the functional block diagram of FIG. 3, a description will be made of a configuration the encryption device according to an embodiment of the present invention. As shown in the block diagram of FIG. 2, the encryption device 1 includes a Central Processing unit (CPU) 11, a Read Only Memory (ROM) 12, a Random Access Memory (RAM) 13, an operation unit 16 and a LAN I/F 14. Each of the units is connected to one another via a bus 15.

The CPU 11 controls each of hardware components of the encryption device 1 via the bus 15. The CPU 11 executes various programs in accordance with a program stored in the ROM 12. The ROM 12 previously stores various programs necessary for an operation of the encryption device 1. The RAM 13 is formed of a Static RAM (SRAM) or the like. The RAM 13 stores temporary data, which is generated when a program is executed, and certification information. In addition, the RAM 13 stores information such as destination address and a public key as a telephone directory database. The operation unit 16 includes a display unit for displaying a status of the encryption device 1 and an instruction unit for providing an operation instruction. The LAN I/F 14 is connected to the LAN 5. The LAN I/F 14 receives a signal from the LAN 5, and transmits a signal and data to the LAN 5. The LAN I/F 14 executes an interface processing such as a signal conversion and a protocol conversion.

FIG. 3 is a functional block diagram showing functions of the encryption device 1. The encryption device 1 includes a control unit 21, a certification information management unit 22, a destination information management unit 23, a mail server management unit 24, an encryption unit 25, a decryption unit 26, an electronic signature generation unit 27, an electronic signature verification unit 28 and a data transmission and reception unit 29. The control unit 21 is formed of the CPU 11 of FIG. 2. The certification information management unit 22, the destination information management unit 23 and the mail server management unit 24 are formed of the RAM 13. The encryption unit 25, the decryption unit 26, the electronic signature generation unit 27, the electronic signature verification unit 28 and the data transmission and reception unit 29 are formed of the CPU 11, the ROM 12 and the RAM 13 of FIG. 2. A function of each of the units is executed by a software program.

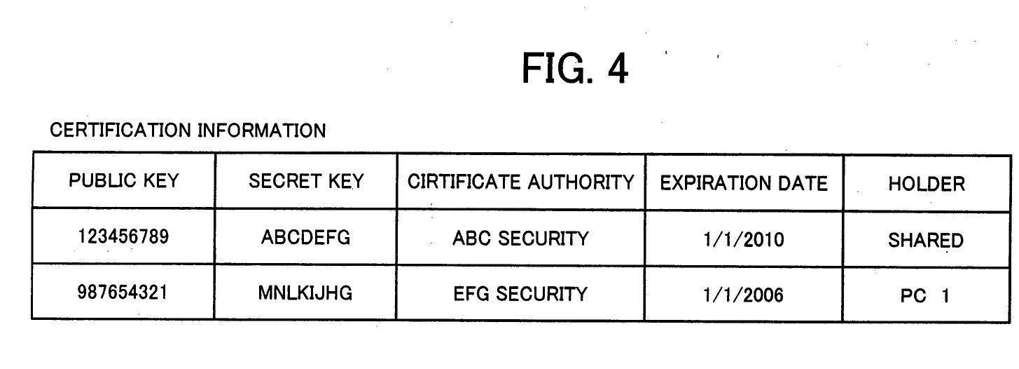

The control unit 21 controls each of the units of the encryption device 1. The certification information management unit 22 stores certification information shown in FIG. 4. As the certification information, the certification information management unit 22 stores a public key, a secret key, a CA, an expiration data and a holder. The certification information management unit 22 stores certification information common to all of clients using the encryption device 1 and certification information used only by an individual client.

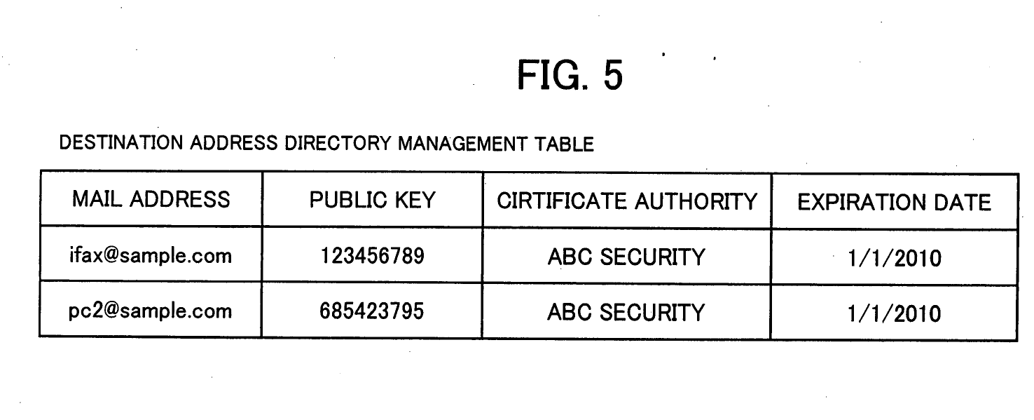

As shown in FIG. 5, the destination information management unit 23 stores a public key, a name of a CA and an expiration date, which are necessary for the encryption, by associating with a mail address of each destination. The mail server management unit 24 stores a domain name and a private Internet Protocol (IP) address of the mail server 3.

The encryption unit 25 encrypts the entire electronic mail or only the main body of the electronic mail by using a public key of a transmission destination. The decryption unit 26 decrypts the entire encrypted electronic mail or the encrypted main body of the electronic mail by using a secret key. The electronic signature generation unit 27 generates an electronic signature by using a secret key, and assigns the electronic signature to the electronic mail. The electronic signature verification unit 28 confirms integrity of the electronic mail, in other words, confirms that the electronic mail is not falsified, by verifying the electronic signature attached to the electronic mail by using a public key of a transmitter of the electronic mail.

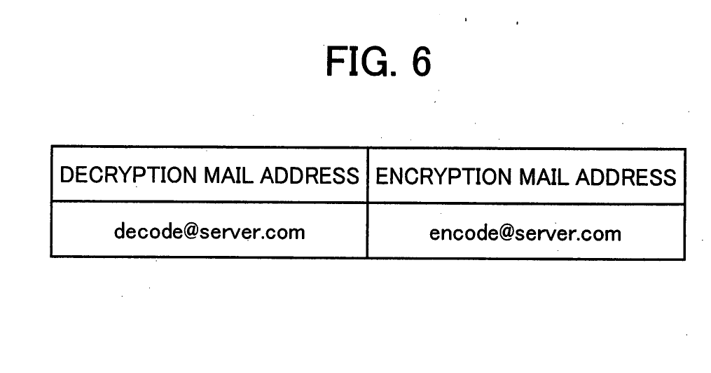

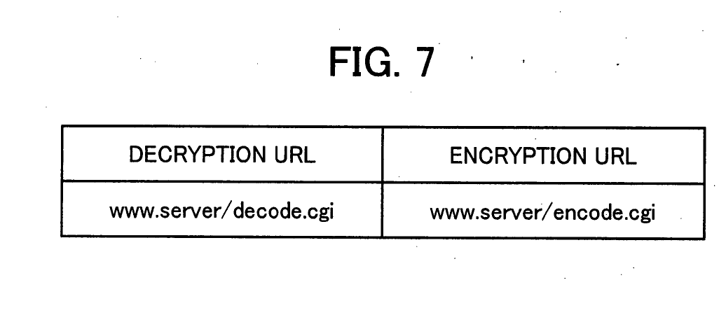

For carrying out a transmission and a reception of electronic mail or data with a client, a decryption mail address (decode@server.com) and an encryption mail address (encode@server.com) as shown in FIG. 6 are assigned to the data transmission and reception unit 29. Accordingly, the data transmission and reception unit 29 as the encryption and decryption I/F can carry out a transmission and a reception of the data by the electronic mail with the client. In place of the decryption mail address and the encryption mail address, a decryption URL (www.server/decode.cgi) and an encryption URL (www.server/encode.cgi) as shown in FIG. 7 can be assigned to the data transmission and reception unit 29. Accordingly, the data transmission and reception unit 29 can carry out a transmission and a reception of the data with the client by the HTTP protocol. As a SMTP mail server, the data transmission and reception unit 29 receives electronic mail and transfers the electronic mail to another mail server.

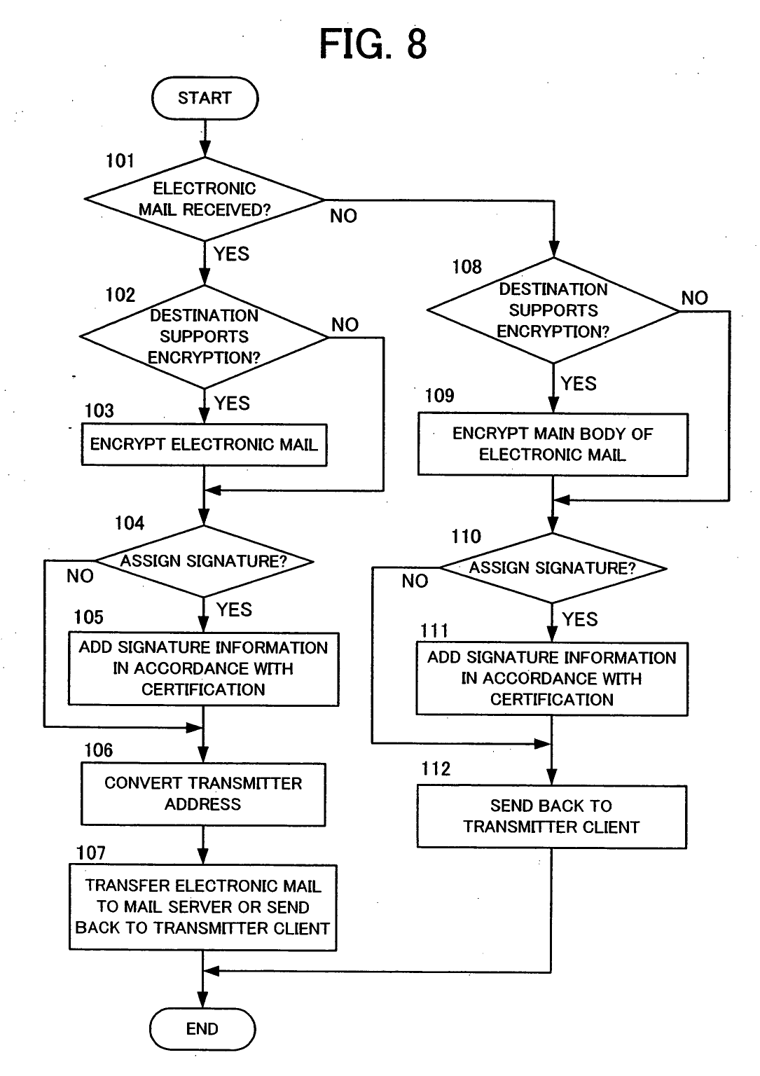

As described above, when the encryption device 1 receives the electronic mail (a) addressed to a destination (not shown) from the Internet facsimile machine 2, the encryption device 1 encrypts the electronic mail and transfers the electronic mail to the mail server 3. When the data (c) including a part to be encrypted and the transmission destination information is transmitted from the Internet facsimile machine 2′ to the encryption and decryption I/F of the encryption device 1 as the main body of the electronic mail, the encryption device 1 encrypts the main body of the electronic mail and sends back to the Internet facsimile machine 2′. Referring to the flowchart of FIG. 8, a description will be made of an operation of the encryption device 1 in this case.

When the data transmission and reception unit 29 receives data from a client, the control unit 21 starts an encryption program shown in the flowchart of FIG. 8. First, the control unit 21 determines whether or not the received data is electronic mail (step 101). When the control unit 21 determines that the received data is the electronic mail, the control unit 21 extracts destination information of a transmission destination from the received electronic mail. Then, the control unit 21 determines whether or not a destination address is a destination address supporting an encryption in accordance with the data stored in the destination information management unit 23 (step 102). When the destination address is not the destination address supporting the encryption, the process proceeds onto step 104. Meanwhile, when the destination address is the destination address supporting the encryption, the control unit 21 encrypts the electronic mail or the main body of the electronic mail by the encryption unit 25 (step 103). That is, the encryption unit 25 uses public key information of the destination registered in the destination information management unit 23 to convert the received electronic mail into encrypted mail. When the electronic mail is received by the encryption and decryption I/F, the encryption unit 25 uses a public key based on the transmission destination information. When the electronic mail is transferred via a mail server to a destination (not shown), the encryption unit 25 uses a public key based on such a destination.

Next, the control unit 21 determines whether or not a setting is made to assign a signature (step 104). When the control unit 21 determines not to assign a signature, the process proceeds onto step 106. When the control unit 21 determines at step 104 to assign a signature, the control unit 21 generates an electronic signature by the electronic signature generation unit 27, and adds the generated electronic signature to the encrypted electronic mail or the mail body of the electronic mail (step 105). That is, the electronic signature generation unit 27 generates a message digest from the entire electronic mail received from the Internet facsimile machine 2 or the main body of the electronic mail received from the Internet facsimile machine 2′ by using a hash function (unilateral digest function). Then, the electronic signature generation unit 27 encrypts the generated message digest by using a secret key managed by the certification information management unit 22, and generates an electronic signature. Further, the setting of whether or not to assign the signature can be changed arbitrarily by the setting of the encryption device 1.

When the addition of the electronic signature is completed, the control unit 21 converts the transmitter address of the encrypted mail into a transmitter address corresponding to the certification (step 106). Then, the data transmission and reception unit 29 transfers the encrypted electronic mail (b) to the private IP address of the mail server 3 stored in the mail server management unit 24. When the encryption device 1 receives the electronic mail by the encryption and decryption I/F, the encryption device 1 sends back the encrypted electronic mail (d) to the Internet facsimile machine 2′, which is a transmitter client (step 107).

Meanwhile, when the data received at step S101 is not the electronic mail and the encryption and decryption I/F receives the data (c) including a part to be encrypted and the transmission destination information as a main body of the electronic mail, the control unit 21 extracts the transmission destination information. Then, the control unit 21 determines whether or not the destination address is a destination address supporting an encryption in accordance with the data stored in the destination information management unit 23 (step 108). When the destination address is the destination address not supporting the encryption, the process proceeds onto step 110. Meanwhile, when the destination address is the destination address supporting the encryption, the control unit 21 encrypts the main body of the electronic mail by the encryption unit 25 in the same manner as described above (step 109). That is, the encryption unit 25 uses the public key information of the destination, and generates data by encrypting the main body of the received electronic mail under a prescribed encryption method.

Next, the control unit 21 determines whether or not a setting is made to assign a signature (step 110). When the control unit 21 determines not to assign the signature, the process proceeds onto step 112. When the control unit 21 determines at step 110 to assign the signature, the control unit 21 generates the electronic signature by the electronic signature generation unit 27 in the same manner as described above, and adds the generated electronic signature to the encrypted main body of the electronic mail (step 111). Then, the control unit 21 sends back the encrypted data (d) from the encryption and decryption I/F of the data transmission and reception unit 29 to the Internet facsimile machine 2′, which is the transmitter client (step 112). Accordingly, the Internet facsimile machine 2′ can format the encrypted data (d) into a form of the encrypted electronic mail (e) and transmit the electronic mail to an actual transmission destination, for example, the Internet facsimile machine 6.

As described above, when a client such as an Internet facsimile machine and a personal computer designates another client as the destination and transmits the electronic mail to the encryption device 1, the electronic mail is encrypted by the encryption device 1 and transferred to the mail server. When data is transmitted from the client to the encryption and decryption I/F of the encryption device 1, the transmitted data is encrypted by the encryption device 1 and sent back to the client of the transmitter. Therefore, the electronic mail encrypted simply can be generated and transmitted to the destination without carrying out the management of the certification and the key or the encryption processing at the client.

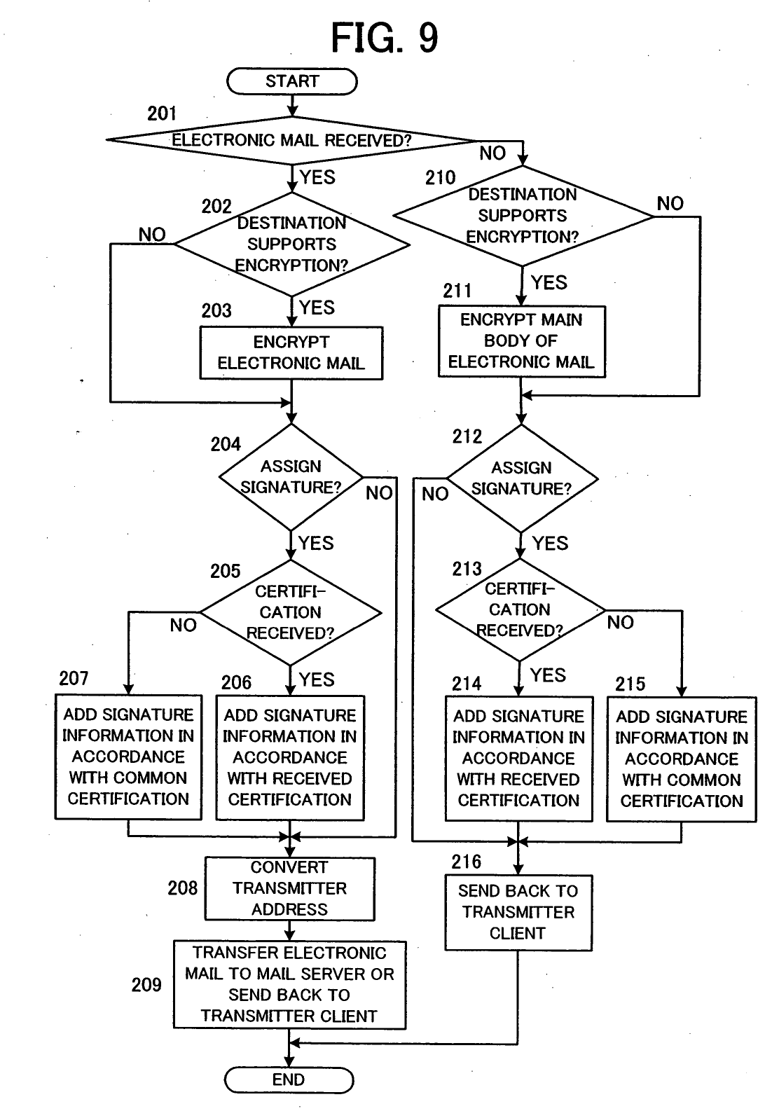

In the above-described embodiment, when generating an electronic signature by the electronic signature generation unit 27, the certification information stored in the certification information management unit 22 is used. However, by transmitting certification information unique to the client along with the encrypted data from the client, the electronic signature can be generated by using the certification information unique to the client. With reference to the flowchart of FIG. 9, a description will be made of an operation of the encryption device 1 when generating the electronic signature by using the certification information unique to the client.

When the data transmission and reception unit 29 receives data from a client, the control unit 21 starts the encryption program shown in the flowchart of FIG. 9. In the same manner as described above, first, the control unit 21 determines whether or not the received data is electronic mail (step 201). When the control unit 21 determines that the received data is the electronic mail, the control unit 21 extracts destination information of a transmission destination from the received electronic mail. The control unit 21 determines whether or not the destination address is a destination address supporting the encryption in accordance with the data stored in the destination information management unit 23 (step 202). When the destination address is a destination address not supporting the encryption, the process proceeds onto step 204. Meanwhile, when the destination address is a destination address supporting the encryption, the control unit 21 encrypts the electronic mail or the main body of the electronic mail by the encryption unit 25 (step 203). Further, when the electronic mail is received by the encryption and decryption I/F, the control unit 21 uses a public key based on the transmission destination information. When the electronic mail is transferred via the mail server to a destination (not shown), the control unit 21 uses a public key based on such a destination.

Next, the control unit 21 determines whether or not a setting is made to assign a signature (step 204). When the control unit 21 determines not to assign a signature, the process proceeds onto step 208. When the control unit 21 determines at step 204 to assign a signature, the control unit 21 determines whether or not a certification of a client is attached to the electronic mail (step 205). When the control unit 21 determines that the certification has been received, the control unit 21 controls the electronic signature generation unit 27 to generate an electronic signature in accordance with the received certification. Then, the control unit 21 adds the generated electronic signature to the encrypted electronic mail or the main body of the electronic mail (step 206).

Meanwhile, when the control unit 21 determines at step S205 that a certification has not received, the control unit 21 controls the electronic signature generation unit 27 to generate the electronic signature in accordance with the certification stored in the certification information management unit 22. Then, the control unit 21 adds the generated electronic signature to the encrypted electronic mail or the main body of the electronic mail (step 207).

When the addition of the electronic signature is completed, the control unit 21 converts the transmitter address of the encrypted mail into a transmitter address corresponding to the certification (step 208). The data transmission and reception unit 29 transfers the encrypted electronic mail (b) to the private IP address of the mail server 3 stored in the mail server management unit 24 (step 209). When the encryption and decryption I/F receives the electronic mail, the control unit 21 sends back the encrypted electronic mail (d) to the Internet facsimile machine 2′, which is a client of the transmitter.

Meanwhile, when the data received from the client at step 201 is not the electronic mail and the encryption and decryption I/F receives the data (c) including a part to be encrypted and the transmission destination information as the main body of the electronic mail, the control unit 21 extracts the transmission destination information. Then, the control unit 21 determines whether or not the destination address is a destination address supporting the encryption in accordance with the data stored in the destination information management unit 23 (step 210). When the destination address is a destination address not supporting the encryption, the process proceeds onto step 212. Meanwhile, when the destination address is a destination address supporting the encryption, the control unit 21 encrypts the main body of the electronic mail by the encryption unit 25 in the same manner as described above (step 211).

Next, the control unit 21 determines whether or not a setting is made to assign a signature (step 212). When the control unit 21 determines not to assign the signature, the process proceeds onto step 216. When the control unit 21 determines at step 212 to assign the signature, the control unit 21 determines whether or not a certification of the client is attached to the received data (step 213). When the control unit 21 determines that the certification has been received, the control unit 21 controls the electronic signature generation unit 27 to generate the electronic signature in accordance with the received certification, and adds the generated electronic signature to the encrypted main body of the electronic mail (step 214).

Meanwhile, when the control unit 21 determines at step 213 that the certification has not been received, the control unit 21 controls the electronic signature generation unit 27 to generate an electronic signature in accordance with the certification stored in the certification information management unit 22, and adds the generated electronic signature to the encrypted main body of the electronic mail (step 215). Then, the control unit 21 sends back the encrypted data (d) from the encryption and decryption I/F of the data transmission and reception unit 29 to the Internet facsimile machine 2′, which is a transmitter client (step 216). As described above, when receiving the data to be encrypted from the client along with the certification information unique to the client, the electronic signature is generated by using the certification information. Therefore, the certification information registered in the encryption device can be shared, and the unique certification information of the client can be used easily.

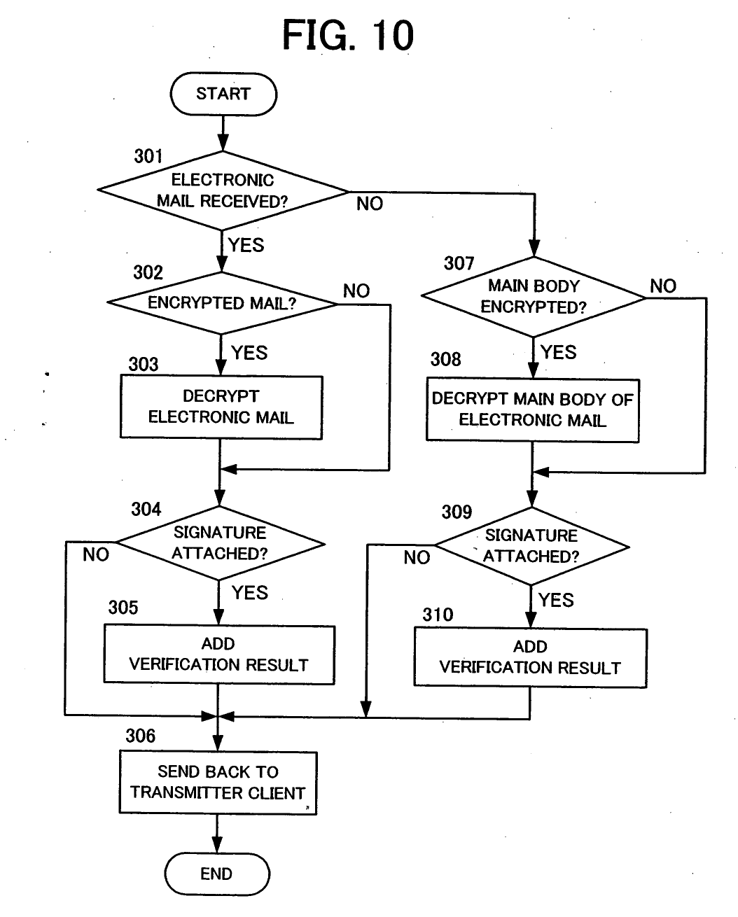

When the client receives encrypted electronic mail (f) from the mail server 3, the received encrypted electronic mail or the encrypted data part extracted from the received electronic mail can be transmitted to the encryption and decryption I/F of the encryption device 1 and decrypted. Referring to the flowchart of FIG. 10, a description will be made of an operation of the encryption device 1 when carrying out a decryption process.

The Internet facsimile machine 2 (or the personal computer 4) periodically receives the electronic mail from the mail server 3 by using account information of the Internet facsimile machine 2 itself (or the personal computer 4 itself). The Internet facsimile machine 2 (or the personal computer 4) determines whether or not the received electronic mail is encrypted. When the received electronic mail is the encrypted electronic mail (f), the Internet facsimile machine 2 (or the personal computer 4) transmits the electronic mail or the encrypted data part extracted from the electronic mail to the decryption mail address (decode@server.com) of the encryption device 1.

When the data transmission and reception unit 29 of the encryption device 1 receives the data (g) via the decryption mail address (decode@server.com), the control unit 21 starts the decryption program shown in the flowchart of FIG. 10. The control unit 21 determines whether or not the received data is electronic mail (step 301). When the control unit 21 determines that the received data is electronic mail, the control unit 21 determines whether or not the received electronic mail is encrypted electronic mail (step 302). When the control unit 21 determines that the received electronic mail is not the encrypted electronic mail, the process proceeds onto step S304. Meanwhile, when the control unit 21 determines at step 302 that the received electronic mail is the encrypted electronic mail, the control unit 21 decrypts the encrypted electronic mail by the decryption unit 26 (step 303). That is, the decryption unit 26 decrypts the encrypted electronic mail by using the secret key stored in the certification information management unit 22.

Next, the control unit 21 determines whether or not an electronic signature is attached to the electronic mail (step 304). When the control unit 21 determines that the electronic signature is not attached, the process proceeds onto step 306. Meanwhile, when the control unit 21 determines that the electronic signature is attached, the control unit 21 verifies the electronic signature by the electronic signature verification unit 28, and adds a verification result to the decrypted electronic mail (step 305). That is, the electronic signature verification unit 28 decrypts the electronic signature by using the public key of the transmitter of the electronic mail stored in the destination information management unit 23, and generates a message digest. Next, the electronic signature verification unit 28 generates a message digest from the entire decrypted electronic mail by a hash function that is the same as the transmitter. Then, the electronic signature verification unit 28 compares the decrypted message digest and the message digest written in the electronic mail, and determines whether or not the decrypted message digest and the message digest written in the electronic mail correspond with one another. Accordingly, the electronic signature verification unit 28 determines whether or not the electronic mail has been falsified. As a result of the determination, the control unit 21 adds a verification result of the electronic signature to the decrypted electronic mail, for example, a comment such as “This mail is proper mail” and a signature content. Then, the control unit 21 sends back the decrypted electronic mail (h) to the personal computer 4, which is a client of the transmitter (step 306).

Meanwhile, when the control unit 21 determines at step 301 that the received data is not the electronic mail but a main body of the electronic mail, the control unit 21 determines whether or not the main body of the electronic mail is encrypted (step 307). When the control unit 21 determines that the main body of the electronic mail is not encrypted, the process proceeds onto step 309. Meanwhile, when the control unit 21 determines that the main body of the electronic mail is encrypted, the control unit 21 decrypts the encrypted main body of the electronic mail by the decryption unit 26 (step 308).

Next, the control unit 21 determines whether or not an electronic signature is attached to the main body of the electronic mail (step 309). When the control unit 21 determines that the electronic signature is not attached, the process proceeds onto step 306. Meanwhile, when the control unit 21 determines that the electronic signature is attached, the control unit 21 verifies the electronic signature by the electronic signature verification unit 28, and adds the verification result to the main body of the decrypted electronic mail (step 310). Then, the control unit 21 sends back the main body of the decrypted electronic mail (h) to the personal computer 4, which is a client of the transmitter (step 306).

As described above, when the encrypted electronic mail or data is transmitted to the encryption device, the electronic mail or the data is sent back after being decrypted. Therefore, even when the Internet facsimile machine or the personal computer does not have a decryption function, the decryption of the encrypted mail can be carried out. When decrypting the electronic mail or the data, the attached signature information is verified and the verification result is added to the decrypted electronic mail or data. Therefore, a confirmation can be made easily as to whether or not the encrypted mail has been falsified.

In the above-described embodiment, an encryption mail address and a decryption mail address are provided as the encryption and decryption I/F of the encryption device, and the encryption and the decryption are carried out between the encryption device and the Internet facsimile machine by the electronic mail. However, as described above, an encryption URL and a decryption URL can be provided to the encryption device, respectively. In such a case, the encryption and the decryption can be carried out between the encryption device and the Internet facsimile machine by the HTTP protocol.

In the above-described embodiment, a description is made of an example in which the Internet facsimile machine requests an encryption processing of the electronic mail or a decryption processing of the encrypted electronic mail to the encryption device. However, the encryption processing and the decryption processing can be carried out according to a request from another client such as a personal computer.

Furthermore, in the above-described embodiment, a determination as to whether or not to add an electronic signature is made according to the setting of the encryption device made by the user. However, a client can separately instruct whether or not to add the electronic signature.

1. An encryption device, comprising:
means for managing address information and certification information;
means for encrypting;
means for transmitting and receiving data; and
means for controlling each of the above means;
wherein when the data from a client received by the means for transmitting and receiving is electronic mail addressed to another device, the means for encrypting encrypts the electronic mail by using the certification information and transfers the encrypted electronic mail to a mail server by the means for transmitting and receiving, and
when data from a client received by the means for transmitting and receiving is not electronic mail addressed to another device, the means for encrypting encrypts data by using the certification information and sends back the encrypted data to the client by the means for transmitting and receiving.

2. The encryption device according to claim 1, wherein the means for encrypting encrypts the data in accordance with the certification information corresponding to final destination information included in the received data.

3. The encryption device according to claim 1, further comprising means for generating signature information;
wherein the means for controlling generates signature information by using the certification information by the means for generating, and adds the generated signature information to the encrypted data.

4. The encryption device according to claim 3, wherein the means for generating generates the signature information in accordance with the certification information corresponding to address information of a transmitter of the data.

5. The encryption device according to claim 3, wherein in case of an absence of certification information corresponding to address information of a transmitter of the data, the means for generating generates the signature information in accordance with common certification information.

6. An encryption device, comprising:
means for managing address information and certification information of a destination;
means for encrypting;
means for transmitting and receiving data; and
means for controlling each of the above means;
wherein when the means for transmitting and receiving receives data from a client, the means for controlling encrypts the data by using the certification information by the means for encrypting and sends back the encrypted data to the client by the means for transmitting and receiving.

7. The encryption device according to claim 6, wherein the means for encrypting encrypts the data in accordance with the certification information corresponding to final destination information included in the received data.

8. The encryption device according to claim 6, further comprising means for generating signature information;
wherein the means for controlling generates signature information by using the certification information by the means for generating and adds the generated signature information to the encrypted data.

9. The encryption device according to claim 8, wherein the means for controlling determines whether or not certification information unique to the client is attached to the data from the client, and when the certification information unique to the client is attached, the means for controlling generates signature information by using the attached certification information by the means for generating.

10. The encryption device according to claim 6, further comprising means for decrypting, wherein when receiving encrypted data from the client, the means for controlling decrypts the data by the means for decrypting and sends back to the client.

11. The encryption device according to claim 10, further comprising means for verifying signature information, wherein when receiving certified data from the client, the means for controlling verifies the signature information by the means for verifying and adds a verification result to the decrypted data.
